(19) United States
(12) Patent Application Publication
(10) Pub. No.: US 2006/0247954 A1
(43) Pub. Date: Nov. 2, 2006

(54) Method and system for scheduling travel ltineraries through an online interface

(75) Inventor: Andrew Hunt, Washington, DC (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: US Airways, Inc., Arlington, VA (US)

(21) Appl. No.: 11/117,613

(22) Filed: Apr. 29, 2005

(51) Int. Cl. G06Q 10/00

(52) U.S. Cl. 705/5

(57) ABSTRACT

A method and system of the present invention are directed to enabling a user to build an itinerary and/or select from a plurality of itineraries based on user input. For example, an embodiment of the present invention may receive user input including travel criteria and generate a single web page which displays a plurality of departure travel segments, a plurality of return travel segments and a price for user selected combinations of departure travel segment and return travel segment where the price is immediately adjusted in response to the user's selection. According to another example, an embodiment of the present invention may receive user input including travel criteria and generate a web page, in response to a single user command where the web page displays a plurality of itineraries where each itinerary may include a departure segment, a return segment and a corresponding price. According to another example, an embodiment of the present invention may receive a user selection of a plurality of tagged itineraries for display on a single web page for user comparison.

### FIELD OF THE INVENTION

The present invention relates generally to scheduling travel itineraries, and more specifically to a web-based system and method for building a trip for a user based on user input, instantly providing travel information in response to a single user command and comparing a plurality of tagged itineraries.

### BACKGROUND OF THE INVENTION

Airlines and other providers currently offer interactive travel services on the Internet that allow consumers to purchase airline travel tickets on-line. Typically, such services require the consumer to input information regarding origination, destination, dates and approximate times of travel. In response, the services display a list of available itineraries that match the input information The consumer then has the option of purchasing a desired flight from the list.

There are many factors that can affect the ultimate price of a desired itinerary. As airlines and other providers strive to be competitive, a customer has many different options from which to choose. Often, the price is the most important factor, particularly for personal travel. Many customers are willing to be flexible on arrival and/or departure times, as well as the number of stops, to obtain a better deal on an itinerary. However, the search to find an optimal itinerary can be time-consuming and oftentimes frustrating for the consumer. Further, the consumer may hold off on purchasing a ticket if the consumer believes that there are better deals available, but not yet discovered. With current systems, the consumer can click through different options (e.g., pairs of departure and arrival segments). However, the consumer usually has to toggle back and forth from the available segments and the price calculation and further keep track of all the various combinations of flight segments to eventually find a good deal.

Many Internet travel services also provide an e-mail service through which subscribers may be notified of available flights based on user criteria (e.g., between specified city pairs). However, such advertised fares are not always available by the time the user logs on to purchase the advertised flight. It is a common frustration for users when an Internet travel service website is accessed in response to such an e-mail notification and the actual flight is not available.

Other drawbacks may also be present.

### SUMMARY OF THE INVENTION

Accordingly, one aspect of the invention is to address one or more of the drawbacks set forth above.

In accordance with an exemplary embodiment of the present invention, a computer implemented method and system for displaying a plurality of travel segments for user selection comprises receiving an origination location and a destination location specified by a user; receiving a departure date and a return date specified by the user; sending a single web page to the user, wherein the single web page displays: a plurality of departure travel segments, each departure travel segment specifying a departure time, an arrival time, a segment identifier and a selection means; a plurality of return travel segments, each return travel segment specifying a departure time, an arrival time, a segment identifier and a selection means; and a price display for displaying a price associated with combinations of departure travel segment and return travel segment; receiving the user's selection of a desired combination of departure travel segment and return travel segment; and immediately adjusting the price display in response to the user's selection, on the single web page.

In accordance with another exemplary embodiment of the present invention, a computer implemented method and system displaying travel itineraries, the method comprising receiving an origination location and a destination location specified by a user; receiving a departure date and a return date specified by the user; receiving a single command from the user to display available itineraries; and in response to the single command, sending a web page to the user, wherein the web page displays a plurality of itineraries, wherein each itinerary comprises: at least one departure travel segment specifying a departure time, an arrival time, and a segment identifier; at least one return travel segment specifying a departure time, an arrival time, and a segment identifier; and a price for the itinerary.

In accordance with another exemplary embodiment of the present invention, a computer implemented method and system for displaying a plurality of itineraries comprises receiving an origination location and a destination location specified by a user; receiving a departure date and a return date specified by the user; sending a web page to the user, wherein the web page displays available travel segments; receiving from the user a selection of a first itinerary, wherein the first itinerary comprises at least two travel segments; receiving from the user a selection of a second itinerary wherein the first itinerary comprises a different combination of at least two travel segments; and sending the user a single web page which displays the first and second itineraries on a single page.

### BRIEF DESCRIPTION OF THE DRAWINGS

FIG. 1 illustrates an exemplary system for searching and scheduling airline travel itineraries, according to an embodiment of the present invention.

FIG. 2 illustrates an exemplary flowchart for enabling a user to build an itinerary, according to an embodiment of the present invention.

FIG. 3 illustrates an exemplary flowchart for providing a plurality of itineraries based on user input, according to an embodiment of the present invention.

FIG. 4 illustrates an exemplary interface for displaying flexible times, according to an embodiment of the present invention.

FIG. 5 illustrates an exemplary interface for displaying flexible dates, according to an embodiment of the present invention.

FIG. 6 illustrates an exemplary flowchart for comparing tagged itineraries, according to an embodiment of the present invention.

### DETAILED DESCRIPTION OF THE INVENTION

An embodiment of the present invention is directed to enabling a user to build an itinerary and/or select from a plurality of itineraries based on user input. For example, an embodiment of the present invention may receive user input including travel criteria and may generate a single web page which displays a plurality of departure travel segments, a plurality of return travel segments and a price for user selected combinations of departure travel segment and return travel segment, where the price is immediately adjusted in response to the user's selection. According to another example, an embodiment of the present invention may receive user input including travel criteria and may generate a web page in response to a single user command where the web page displays a plurality of itineraries where each itinerary may include a departure segment, a return segment and a corresponding price. According to another example, an embodiment of the present invention may receive a user selection of a plurality of tagged itineraries for display on a single web page for user comparison.

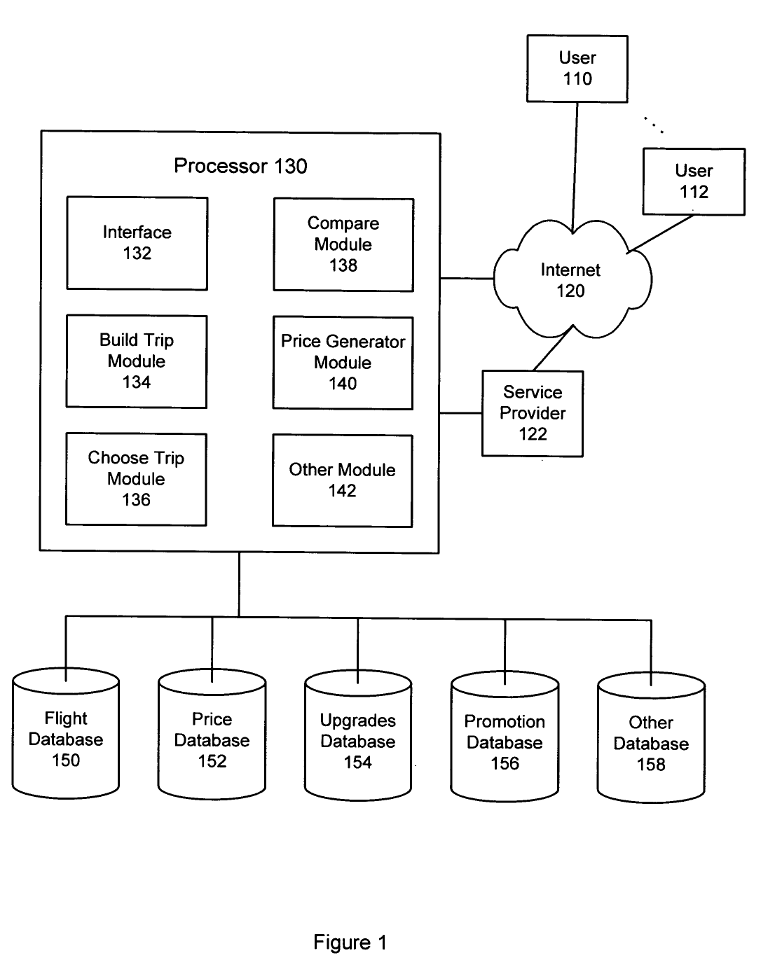

FIG. 1 illustrates an exemplary system for searching and scheduling airline travel itineraries, according to an embodiment of the present invention. A user, such as user 110 and user 112, may access a user interface provided by Processor 130 through a communication channel, such as Internet 120. Communication channel may include a wired Internet channel, a wireless channel and/or other communication medium. For example, the user may access the interface via a computer, laptop, PDA, or other remote device. Users may interface with a Service Provider 122, which may be in communication with Processor 130 where Service Provider 122 and Processor 130 are remote from each other. According to another example, Service Provider 122 may be combined with Processor 130, as a single entity or related entity. Service Provider 122 may include an airline reservation system, an airline service provider, an airline ticket provider, travel agent, airline carrier, a third party provider and/or other entity. Other architectures may be realized.

An embodiment of the present invention enables user 110 to communicate with Processor 130 to search and schedule a travel itinerary. Processor 130 may include various modules for performing functions associated with generating itinerary schedules. In this exemplary embodiment, Processor 130 may include Interface 132, Build Trip Module 134, Choose Trip Module 136, Compare Module 138, Price Generator Module 140 and/or other module 142. The modules of Processor 130 may be further combined, duplicated and/or separated. The modules may also be provided across multiple processors, systems and/or other devices. While the modules are illustrated within a single system, other system architectures may be realized. For example, the modules may exist across multiple systems, located at the same or different locations. While the modules and other elements are shown as a single component, each component may be reiterated.

Processor 130 may communicate with various databases, sources of information, front end devices, and/or other modules. Databases may include Flight Database 150, Price Database 152, Upgrades Database 154, Promotion Database 156 and/or Other Database 158. The databases may be combined and/or further separated. In addition, the databases may be situated at the same location or spread across multiple systems, processors, etc. One or more databases may be remote from Processor 130. For example, one or more databases may be associated with Service Provider 122. Flight Database 150 may include flight data for available flights. Flight data may include flight number, flight departure time, flight arrival time, number of stops, duration, etc. Price Database 152 may include price data concerning various flights and/or combinations of flight segments. A pricing algorithm may be applied to the price data to generate prices for various flights. Price data may be updated and/or revised. Upgrades Database 154 may include data concerning upgrades and/or other services available to passengers for various flights. Promotion Database 156 may include data associated with promotions, sales and/or other incentives.

Interface 132 may include a user interface that receives user input and generates web pages in response to the user input. Interface 132 may include customized user information. For example, user 110 may convey identification information (e.g., name, preferences, etc.), security information (e.g., user ID, password (or PIN), etc.), payment information (e.g., credit card, expiration date, security code, billing address, etc.) and/or other information. Flight information, such as travel preferences, saved trips, recent trips, etc., may also be stored and/or received by Interface 132. Other information may also be submitted. For example, a user may access a Service Provider 122 via an Internet connection or other communication medium where Processor 130 may provide back-end functionality to Service Provider 122. The user may enter itinerary criteria, which may include departure location (e.g., city, region, airport(s), etc.), arrival location (e.g., city, region, airport(s), etc.), times (e.g., time ranges, intervals, etc.), dates of travel and/or other information. For example, other itinerary information may include class preference, meal preference, special needs, seat preference, etc.

Build Trip Module 134 may receive user input, such as itinerary criteria. Based on the user input, Build Trip Module 134 may provide a listing of possible departure segments and return segments where the user may select a preferred pair and automatically immediately view pricing information on a same web page. The pricing information may dynamically adjust based on the user's selection of departure and/or return segments. Other information may be received to further dynamically adjust the price.

Choose Trip Module 136 may receive user input, such as itinerary criteria. Based on the user input, Choose Trip Module 136 may provide a listing of possible itineraries, which may include departure segment, return segment and price. The user may then select a desired itinerary.

Compare Module 138 may receive a plurality of tagged itineraries, which may be user selected or automatically generated. Compare Module 138 may provide a listing of tagged itineraries that may be compared by the user. For example, during a search of itineraries, a user may tag a plurality of itineraries for comparison. In another example, a user may select to compare all itineraries that meet a certain criteria, such as under a dollar amount, with no stops, from a preferred airport, within an arrival time frame and/or other criteria. The listing of tagged itineraries may by sorted by various factors, such as price, arrival time, departure time, duration of flight, etc. Other functions as well as other forms of data manipulation may be available.

Price Generator Module 140 may generate pricing data based on various combinations of departure segment and return segment. Price Generator Module 140 may include a pricing algorithm that may be updated and/or adjusted. For example, prices may be adjusted (e.g., reduced, increased, modified, etc.) based on business decisions, promotions and/or other considerations. For example, the pricing algorithm may generate itineraries and/or segments based on various data, such as flight time, connection time, on-time history, class of service availability (e.g., first class, coach, envoy, etc.), flight duration, percent of seats sold, aircraft type, and/or other factors. Pricing Generator Module 140, while illustrated as being a separate module, may be combined with Build Trip Module 134, Choose Trip Module 136 and/or other travel scheduling module, for example.

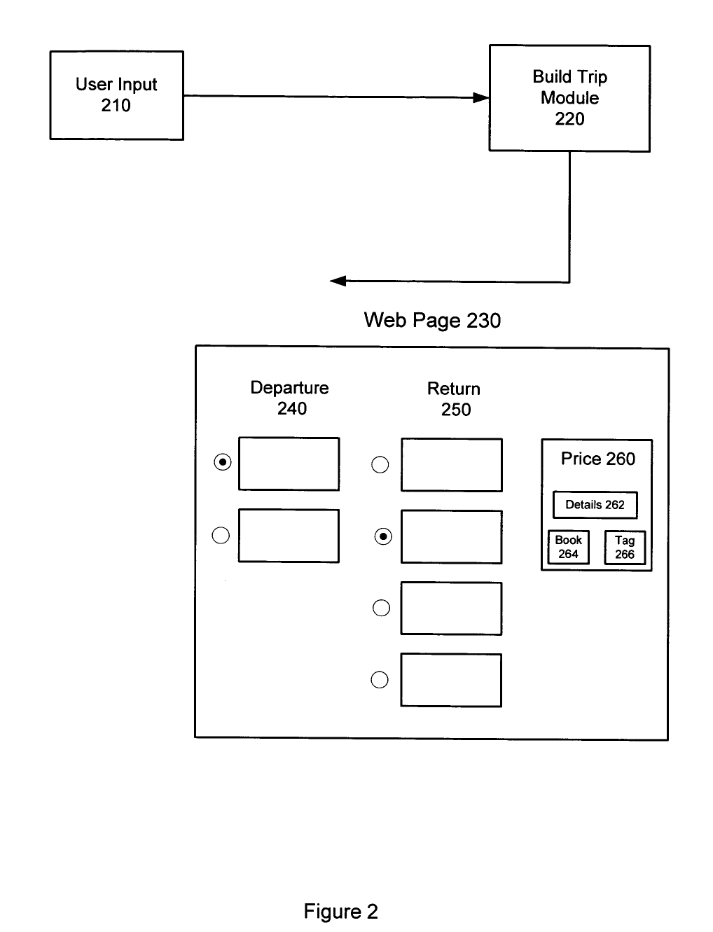

FIG. 2 illustrates an exemplary flowchart for enabling a user to build an itinerary, according to an embodiment of the present invention. A user may provide travel input to a user interface (e.g., Interface 132) through a communication channel. Build Trip Module 220 may receive user input 210 and generate a web page 230, in response. User Input 210 may include itinerary criteria, such as origination (e.g., city, region, airport(s), etc.), destination (e.g., city, region, airport(s), etc.), departure date (e.g., date, time range, morning, afternoon, evening, etc.), return date (e.g., date, time range, morning, afternoon, evening, etc.) and/or other criteria. In response to User Input 210, Build Trip Module 220 may generate web page 230 for providing possible travel segments for user selection. For example, web page 230 may provide Departure Segment 240, Return Segment 250 and Price Box 260. Departure Segment 240 may include a list of possible departure segments based on the user input. Departure segments may include flight number, departure time and location, arrival time and location, duration, number of stops and/or other flight details. Return Segment 250 may include a list of possible return segments based on the user input. Return segments may include flight number, departure time and location, arrival time and location, duration, number of stops and/or other flight details. The user may select a combination of departure segment and return segment. For example, the user may click on a corresponding button, as shown. Price Box 260 may include a price for the selected combination of departure segment and return segment. Other details 262 may also be included. Details may include price details, price breakdown, flight information, etc. The user may book, schedule or purchase the selected itinerary by selecting Book 264 or other command. The user may also tag the selected itinerary by selecting Tag 266 for consideration, comparison, hold and/or other action.

According to an embodiment of the present invention, a user may select a departure segment and return segment and immediately view a corresponding price on Price Box 260. By selecting a different combination of departure segment and return segment, the Price Box 260 may dynamically and immediately adjust to display the corresponding price for that combination. According to another example, the user may select one or more departure segments and one or more return segments to view a plurality of possible pricing options, which may be displayed by Price 260 (e.g., multiple price boxes may also be displayed).

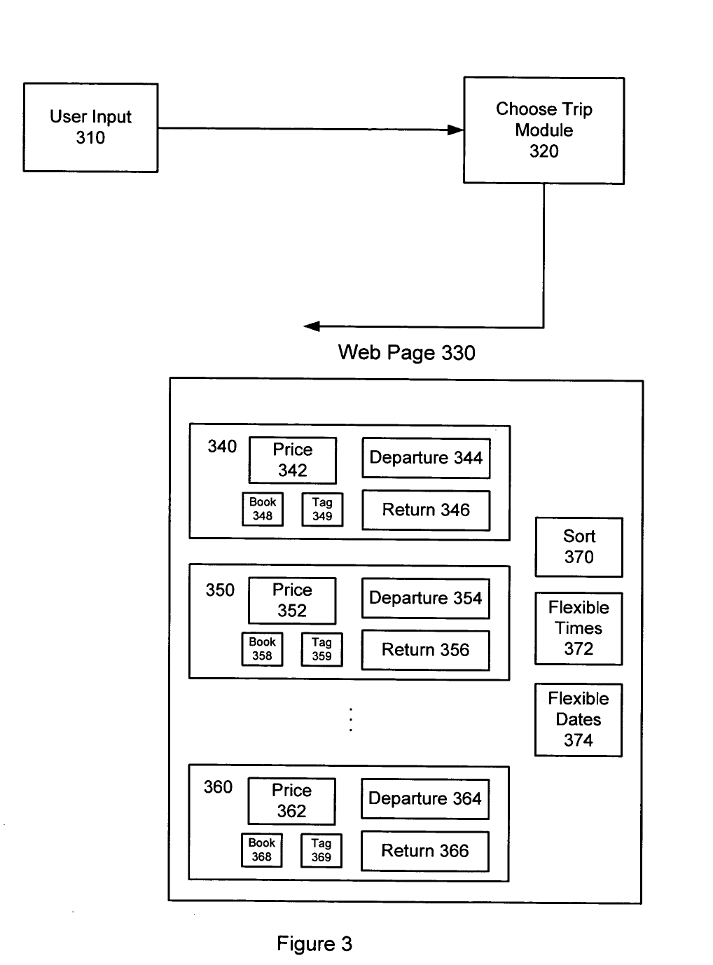

FIG. 3 illustrates an exemplary flowchart for providing a plurality of itineraries based on user input, according to another embodiment of the present invention. A user may provide travel input to a user interface (e.g., Interface 132) through a communication channel. Choose Trip Module 320 may receive user input 310 and generate a web page 330, in response. User Input 310 may include itinerary criteria, such as origination (e.g., city, region, airport(s), etc.), destination (e.g., city, region, airport(s), etc.), departure date (e.g., date, time range, morning, afternoon, evening, etc.), return date (e.g., date, time range, morning, afternoon, evening, etc.) and/or other criteria. In response to User Input 310, Choose Trip Module 320 may generate web page 330 for providing possible itineraries for user selection, in response to single user command (e.g., one click).

For example, web page 330 may provide a first itinerary 340, a second itinerary 350, a third itinerary 360, etc. Each respective itinerary may include Price Segment (342, 352, 362), Departure Segment (344, 354, 364) and Return Segment (346, 356, 366). Price Segment 342 may include a price for the associated combination of Departure Segment 344 and Return Segment 346. Departure Segment 344 may include flight number, departure time and location, arrival time and location, duration, number of stops and/or other flight details. Return Segment 346 may include flight number, departure time and location, arrival time and location, duration, number of stops and/or other flight details. The user may book, schedule or purchase itinerary 340 by selecting Book 348 or other command. The user may also tag itinerary 340 by selecting Tag 349 for consideration, comparison, hold and/or other action. According to an embodiment of the present invention, a user may select an itinerary from the available list of itineraries.

For Itinerary 350, Price Segment 352 may include a price for the associated combination of Departure Segment 354 and Return Segment 356. Departure Segment 354 may include flight number, departure time and location, arrival time and location, duration, number of stops and/or other flight details. Return Segment 356 may include flight number, departure time and location, arrival time and location, duration, number of stops and/or other flight details. The user may book, schedule or purchase itinerary 350 by selecting Book 358 or other command. The user may also tag itinerary 350 by selecting Tag 359 for consideration, comparison, hold and/or other action. According to an embodiment of the present invention, a user may select an itinerary from the available list of itineraries.

For Itinerary 360, Price Segment 362 may include a price for the associated combination of Departure Segment 364 and Return Segment 366. Departure Segment 364 may include flight number, departure time and location, arrival time and location, duration, number of stops and/or other flight details. Return Segment 366 may include flight number, departure time and location, arrival time and location, duration, number of stops and/or other flight details. The user may book, schedule or purchase itinerary 360 by selecting Book 368 or other command. The user may also tag itinerary 360 by selecting Tag 369 for consideration, comparison, hold and/or other action. According to an embodiment of the present invention, a user may select an itinerary from the available list of itineraries.

In addition, various options may be available to the user, such as a sort function provided by Sort 370. Additional information may be inputted by the user to display Flexible Times 372 and Flexible Dates 374, for example. Sort 370 enables a user may sort the list of itineraries by various factors, such as price, time, duration, number of stops, departure times, arrival times, and/or other factors. Flexible Times 372 enables a user to view additional times, time frames and/or other data to expand the list of possible itineraries. For example, a user may expand a departure window of time and/or an arrival window of time. The user may view a predetermined set of available times in relation to a selected time, e.g., the time desired by the user. In addition, the user may select or enter flexible times or time frames. Thus, the user may select a desired level of flexibility. Flexible Dates 372 enables a user to view alternative dates to expand the list of possible itineraries. In addition, the user may select or enter alternative dates. By inputting additional information, Web Page 330 may be updated to include the additional itineraries.

For example, a user may expand original times to include +/−6 hours so that additional itineraries may be generated. Other increments of time (+/−1 hour, +/−4 hours, +/−12 hours, etc.) and/or other criteria (e.g. plus 8 hours, less than 24 hours, less than a dollar amount, etc.) may be considered. The user may initially specify in User Input 310 that the departure date is June 10 in the morning. By selecting Flexible Times 372, the user may specify departure date to include afternoon and/or evening times. Flexible Dates 374 may enable the user to include additional dates of departure and/or arrival to further expand the list of possible itineraries. The incremental changes may be user specified or automatically generated. For example, by selecting Flexible Times 372, the system may automatically expand the times by +/−6 hours. According to another example, the user may be willing to expand the departure time by 8 hours. Other time increments may be applied. For example, by selecting Flexible Dates 374, the system may automatically expand time frames by a predetermined number of days. According to another example, the user may specify an expanded schedule for the next week. Other variations and time increments may be applied.

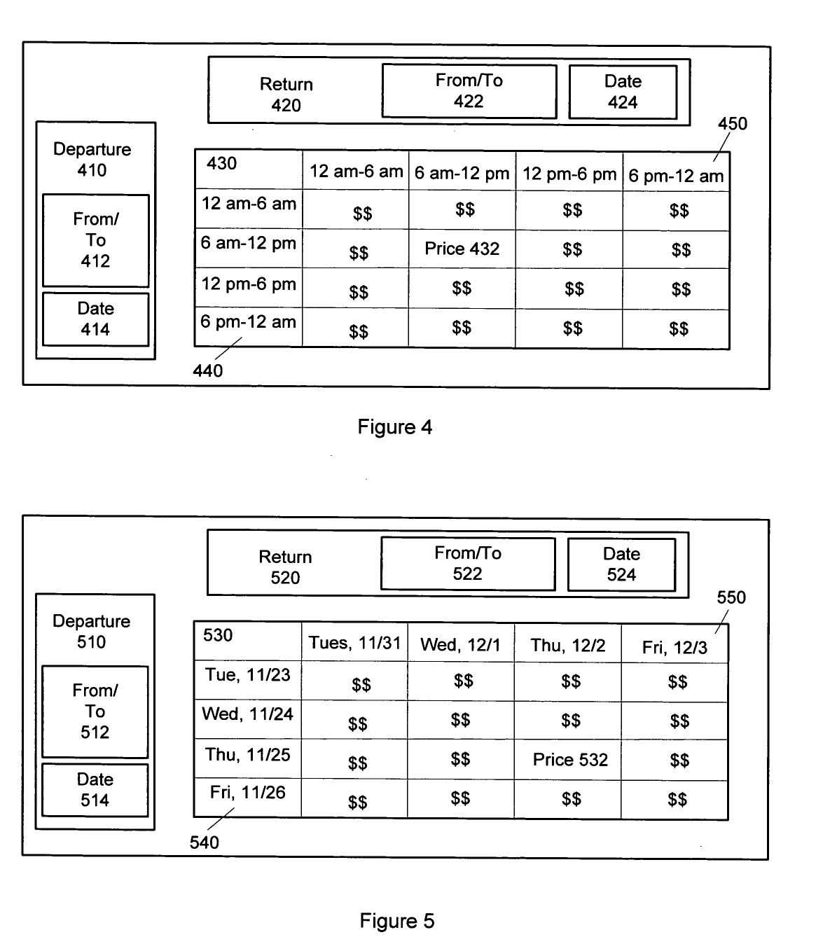

FIG. 4 illustrates an exemplary interface for displaying flexible times, according to an embodiment of the present invention. As shown in FIG. 4, for a selected itinerary, an embodiment of the present invention may offer additional options based on flexible times. The highlighted price may be selected by the user or automatically selected. Departure 410 segment may include origination information 412, Departure Date 414 and/or other information. Return 420 segment may include return information 422, Return Date 424 and/or other information. A trip may be highlighted, as shown by 432. Other available flights may be displayed in relation to the highlighted trip 432. Grid 430 may include departure times 440 and return times 450. The prices displayed may be an actual price, a range of prices, starting price, up to price and/or other variation thereof. While increments of 6 hours are shown for exemplary purposes in grid 430, other increments of time may be displayed. Larger increments, smaller increments, variable increments, and/or other time frames may be displayed. For example, many flights may depart in the morning hours so that the 6 am-12 pm increment may be replaced with multiple time increments, such as 6 am-8 am, 8 am-10 am, 10 am to 12 pm, to display a more accurate list of options.

FIG. 5 illustrates an exemplary interface for displaying flexible dates, according to an embodiment of the present invention. As shown in FIG. 5, for a selected itinerary, an embodiment of the present invention may offer additional options based on flexible dates. The highlighted price may be selected by the user or automatically selected. Departure 510 segment may include origination information 512, Departure Date 514 and/or other information. Return 520 segment may include return information 522, Return Date 524 and/or other information. A trip may be highlighted, as shown by 532. Other available flights may be displayed in relation to the highlighted trip 532. Grid 530 may include departure dates 540 and return dates 550. The prices displayed may be an actual price, a range of prices, starting price, up to price and/or other variation thereof. Other time increments of dates and/or times may be displayed.

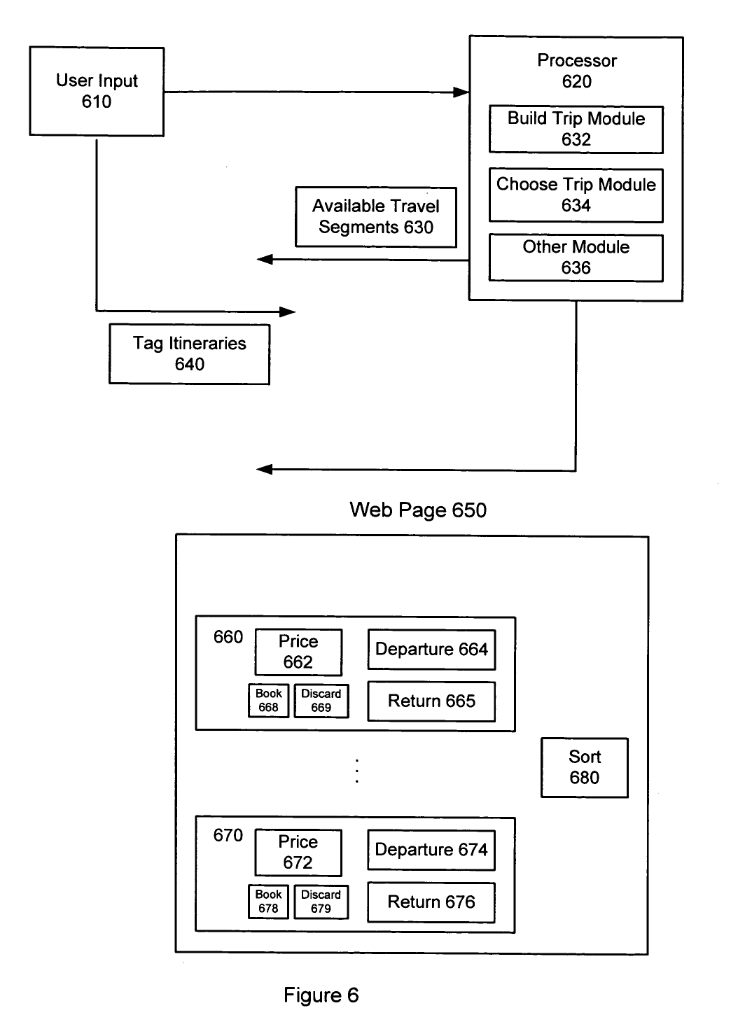

FIG. 6 illustrates an exemplary flowchart for comparing tagged itineraries, according to an embodiment of the present invention. A user may provide travel input to a user interface (e.g., Interface 132) through a communication channel. Processor 620 may receive user input and generate a web page of available travel segments and/or itineraries, in response. User Input 610 may include itinerary criteria, such as origination (e.g., city, region, airport(s), etc.), destination (e.g., city, region, airport(s), etc.), departure date (e.g., date, time range, morning, afternoon, evening, etc.), return date (e.g., date, time range, morning, afternoon, evening, etc.) and/or other criteria. In response to User Input 610, Processor 620 may generate a web page of available travel segments 630 to the user. Available travel segments 630 may include available segments and/or itineraries as provided by Build Trip Module 620, as illustrated in FIG. 2 above, Choose Trip Module 620, as illustrated in FIG. 3 above and/or other method provided by other module 636.

According to an embodiment of the present invention, a user may select or tag one or more combinations of departure segment and return segment. In another example, the user may select or tag a plurality of itineraries for comparison. The user may tag the combinations of segments and/or itineraries, as shown by 640. In response, web page 650 may be generated to show a comparison of the tagged itineraries, as selected by 640.

For example, web page 650 may include a plurality of itineraries as shown by 660 and 670. Itinerary 660 may include price 662, departure segment 664 and return segment 665. The user may book, schedule or purchase itinerary 660 by selecting Book 668 or other command. The user may also discard the selected itinerary by selecting Discard 669 to further narrow the comparison. Itinerary 670 include price 672, departure segment 674 and return segment 676. Sort 680 may enable the user to sort the results by various factors, such as price, departure time, arrival time, duration, number of stops, etc. Similar to Itinerary 660, the user may book, schedule or purchase itinerary 670 by selecting Book 678 or other command. The user may also discard itinerary 670 by selecting Discard 679 to further narrow the comparison. Other functions may provide other comparison features, such as Sort 680. The user may sort the tagged itineraries by various factors, such as price, duration, number of stops, arrival times, departure times, etc.

According to an embodiment of the invention, the systems and processes described above invention may be implemented on any general or special purpose computational device, either as a standalone application or applications, or even across several general or special purpose computational devices connected over a network and as a group operating in a client-server mode. According to another embodiment of the invention, a computer-usable and writeable medium having a plurality of computer readable program code stored therein may be provided for practicing the process of the present invention. The process and system of the embodiments of the present inventions may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the embodiments of the present inventions may comprise computer readable program code in the form of functional instructions stored in the computer-usable medium such that when the computer-usable medium is installed on the system or systems, those components cause the system to perform the functions described. The computer readable program code for the embodiments of the present inventions may also be bundled with other computer readable program software. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

1. A computer implemented method for displaying a plurality of travel segments for user selection, the method comprising the steps of:
receiving an origination location and a destination location specified by a user;
receiving a departure date and a return date specified by the user;
sending a single web page to the user, wherein the single web page displays:
a plurality of departure travel segments, each departure travel segment specifying a departure time, an arrival time, a segment identifier and a selection means;
a plurality of return travel segments, each return travel segment specifying a departure time, an arrival time, a segment identifier and a selection means; and
a price display for displaying a price associated with combinations of departure travel segment and return travel segment;
receiving the user's selection of a desired combination of departure travel segment and return travel segment; and
immediately adjusting the price display in response to the user's selection, on the single web page.

2. The method of claim 1, wherein the plurality of departure travel segments are arranged in a first column and the plurality of return travel segments are arranged in a second column on the single web page.

3. The method of claim 1, further comprising the steps of:
receiving a second desired combination of departure travel segment and return travel segment from the user; and
immediately adjusting the price display in response to the user's second selection, on the single web page.

4. The method of claim 1, further comprising the step of:
receiving a tag command from the user for one or more desired combinations of departure travel segment and return travel segment.

5. The method of claim 4, further comprising the step of:
displaying a plurality of tagged combinations for user comparison.

6. The method of claim 1, further comprising the step of:
receiving a purchase command from the user for the desired combination of departure travel segment and return travel segment.

7. A computer implemented system for displaying a plurality of travel segments for user selection, the system comprising:
an interface for receiving an origination location, a destination location, a departure date and a return date specified by a user; and
a build trip module for sending a single web page to the user, wherein the single web page displays:
a plurality of departure travel segments, each departure travel segment specifying a departure time, an arrival time, a segment identifier and a selection means;
a plurality of return travel segments, each return travel segment specifying a departure time, an arrival time, a segment identifier and a selection means; and
a price display for displaying a price associated with combinations of departure travel segment and return travel segment;
wherein the interface receives the user's selection of a desired combination of departure travel segment and return travel segment and wherein the price display is immediately adjusted in response to the user's selection, on the single web page.

8. The system of claim 7, wherein the plurality of departure travel segments are arranged in a first column and the plurality of return travel segments are arranged in a second column on the single web page.

9. The system of claim 7, wherein the interface receives a second desired combination of departure travel segment and return travel segment from the user and wherein the price display is immediately adjusted in response to the user's second selection, on the single web page.

10. The system of claim 7, wherein a tag command is received from the user for one or more desired combinations of departure travel segment and return travel segment.

11. The system of claim 10, further comprising:
a display for displaying a plurality of tagged combinations for user comparison.

12. The system of claim 7, wherein a purchase command is received from the user for the desired combination of departure travel segment and return travel segment.

13. A computer implemented method for displaying travel itineraries, the method comprising the steps of:
receiving an origination location and a destination location specified by a user;
receiving a departure date and a return date specified by the user;
receiving a single command from the user to display available itineraries; and
in response to the single command, sending a web page to the user, wherein the web page displays a plurality of itineraries, wherein each itinerary comprises:
at least one departure travel segment specifying a departure time, an arrival time, and a segment identifier;
at least one return travel segment specifying a departure time, an arrival time, and a segment identifier; and
a price for the itinerary.

14. The method of claim 13, wherein the single command is a single click of a user input device.

15. The method of claim 13, further comprising the step of:
receiving a purchase command from the user for a selected itinerary.

16. The method of claim 13, further comprising the step of:
receiving a tag command from the user for one or more desired itineraries.

17. The method of claim 15, further comprising the step of:
displaying a plurality of tagged itineraries for user comparison.

18. The method of claim 13, further comprising the step of:
displaying a plurality of additional travel segments in a grid display, wherein the at least one additional travel segment comprises a time increment of one or more of the departure date and the return date.

19. The method of claim 18, wherein the time increment comprises a predetermined number of hours.

20. The method of claim 18, wherein the time increment comprises a predetermined number of days.

21. The method of claim 13, further comprising the step of:
displaying at least one additional departure time in relation to the user specified departure date.

22. The method of claim 21, wherein the additional departure time comprises a predetermined number of day increment.

23. The method of claim 21, wherein the additional departure time comprises a predetermined number of hours increment.

24. The method of claim 13, further comprising the step of:
displaying at least one additional return time in relation to the user specified return date.

25. The method of claim 24, wherein the additional departure time comprises a predetermined number of day increment.

26. The method of claim 24, wherein the additional departure time comprises a predetermined number of hours increment.

27. A computer implemented system for displaying travel itineraries, the system comprising:
an interface for receiving an origination location, a destination location, a departure date and a return date specified by a user and for receiving a single command from the user to display available itineraries; and
a choose trip module for sending a web page to the user in response to the single command, wherein the web page displays a plurality of itineraries and each itinerary comprises:
at least one departure travel segment specifying a departure time, an arrival time, and a segment identifier;
at least one return travel segment specifying a departure time, an arrival time, and a segment identifier; and
a price for the itinerary.

28. The system of claim 27, wherein the single command is a single click of a user input device.

29. The system of claim 27, wherein a purchase command is received from the user for a selected itinerary.

30. The system of claim 27, wherein a tag command is received from the user for one or more desired itineraries.

31. The system of claim 30, further comprising:
a display for displaying a plurality of tagged itineraries for user comparison.

32. The system of claim 27, further comprising:
a display for displaying a plurality of additional travel segments in a grid display, wherein the at least one additional travel segment comprises a time increment of one or more of the departure date and the return date.

33. The system of claim 32, wherein the time increment comprises a predetermined number of hours.

34. The system of claim 32, wherein the time increment comprises a predetermined number of days.

35. The system of claim 27, further comprising:
a display for displaying at least one additional departure time in relation to the user specified departure date.

36. The system of claim 35, wherein the additional departure time comprises a predetermined number of day increment.

37. The system of claim 35, wherein the additional departure time comprises a predetermined number of hours increment.

38. The system of claim 27, further comprising:
a display for displaying at least one additional return time in relation to the user specified return date.

39. The system of claim 38, wherein the additional departure time comprises a predetermined number of day increment.

40. The system of claim 38, wherein the additional departure time comprises a predetermined number of hours increment.

41. A computer implemented method for displaying a plurality of itineraries, the method comprising the steps of:
receiving an origination location and a destination location specified by a user;
receiving a departure date and a return date specified by the user;
sending a web page to the user, wherein the web page displays available travel segments;
receiving from the user a selection of a first itinerary, wherein the first itinerary comprises at least two travel segments;
receiving from the user a selection of a second itinerary, wherein the first itinerary comprises a different combination of at least two travel segments; and
sending the user a single web page which displays the first and second itineraries on a single page.

42. The method of claim 41, further comprising the steps of:
sorting the itineraries based on a user selected criteria.

43. The method of claim 42, wherein the user selected criteria comprises one or more of price, departure time, arrival time, number of stops and duration of flight.

44. A computer implemented system for displaying a plurality of itineraries, the system comprising:
an interface for receiving an origination location, a destination location, a departure date and a return date specified by a user;
a trip module for sending a web page to the user, wherein the web page displays available travel segments;
wherein the interface receives a selection of a first itinerary from the user, the first itinerary comprising at least two travel segments and wherein the interface further receives a selection of a second itinerary from the user, the first itinerary comprising a different combination of at least two travel segments; and
a compare module for sending the user a single web page which displays the first and second itineraries on a single page.

45. The system of claim 44, further comprising:
a sort function for sorting the itineraries based on a user selected criteria.

46. The system of claim 45, wherein the user selected criteria comprises one or more of price, departure time, arrival time, number of stops and duration of flight.
